(19) United States
(12) Patent Application Publication
(10) Pub. No.: US 2026/0358520 A1
(43) Pub. Date: Nov. 12, 2026

(54) DETECTING UNCONVENTIONAL HYDROCARBON PROSPECTS USING GEOPHYSICAL DATA

(71) Applicant: Daniel A. Ebrom, Katy, TX (US)

(72) Inventor: Daniel A. Ebrom, Katy, TX (US)

(21) Appl. No.: 19/671,915

(22) Filed: May 8, 2026

Related U.S. Application Data
(60) Provisional application No. 63/803,470, filed on May 9, 2025.

(51) Int. Cl. G01V 1/30

(52) U.S. Cl. CPC G01V 1/303; G01V 1/301

(57) ABSTRACT

A method for identifying unconventional hydrocarbon prospects using reflection seismic data acquired proximate an area of Earth's subsurface to be evaluated includes determining interval velocities at a plurality of locations proximate the area. A normal compaction trend of seismic velocities in shale formations proximate the area is determined. One or more low velocity anomalies are determined from the interval velocities and the normal compaction trend. At least one unconventional hydrocarbon prospect location is identified from the one or more low velocity anomalies.

### CROSS REFERENCE TO RELATED APPLICATIONS

Priority is claimed from U.S. Provisional Application No. 63/803,470 filed on May 9, 2025.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of exploration for hydrocarbon deposits in the Earth's subsurface. More particularly, the disclosure relates to methods for detecting unconventional subsurface hydrocarbon deposits using seismic energy.

Conventional oil and gas (hydrocarbon) prospect evaluations have made use of reflection seismic technology for the last hundred years. Reflection seismic technology is generally used to identify such conventional prospects, which may be present in subsurface formations that are permeable to fluid flow, and have structure that defines an enclosed volume overlain by impermeable formations so as to trap upwardly migrating hydrocarbons.

Seismic is only sporadically applied to unconventional oil and gas prospects, however. This is primarily due to the geological differences between conventional and unconventional oil and gas prospects. Conventional oil and gas prospects frequently have a structural component and so reflection seismic is often used to map the hydrocarbon trap, i.e., the above described enclosed volume.

Unconventional hydrocarbon prospects frequently lack a structural component. What characterizes many unconventional hydrocarbon prospects is a source rock having organic content that is still in the process of being thermally converted to hydrocarbons. The thermal conversion of kerogen (the organic content) to hydrocarbons creates overpressures, that is fluid pressures exceeding the hydrostatic gradient, and leads to fracturing of the source rock and gradual escape of the diagenetically produced oil and gas. The overpressure causes both the source rock and the surrounding rock (into which the overpressured source rock fluids have escaped) to have lower seismic interval velocities than would be the case if the formation fluid pressures were at the hydrostatic gradient.

### SUMMARY

One aspect of the present disclosure is a method for identifying unconventional hydrocarbon prospects. A method according to this aspect uses reflection seismic data acquired proximate an area of Earth's subsurface to be evaluated. The method includes determining interval velocities at a plurality of locations proximate the area. A normal compaction trend of seismic velocities in shale formations proximate the area is determined. One or more low velocity anomalies are determined from the interval velocities and the normal compaction trend. At least one unconventional hydrocarbon prospect location is identified from the one or more low velocity anomalies. A display or map may be generated to show the geodetic location of the at least one prospect.

In another aspect, the foregoing process includes the actions of acquiring seismic data by actuating at least one seismic energy source and detecting seismic energy at a plurality of seismic detectors disposed proximate the area. Such acquired seismic data may be used in accordance with the present disclosure.

A non-transitory computer readable medium according to another aspect comprises a computer program stored thereon. The computer program is operable to cause a programmable computer to perform, on reflection seismic data acquired proximate an area of Earth's subsurface to be evaluated, the acts described above for a method according to the present disclosure.

In some implementations, the interval velocities are determined using at least one of the Dix equation or full waveform inversion.

In some implementations, the one or more low velocity anomalies are determined by calculating a difference cube.

Some implementations further comprise calculating fluid pressure in at least one subsurface formation by converting a magnitude of the one or more low velocity anomalies using Eaton's equation.

Other aspects and possible advantages will be apparent from the description and claims that follow.

### BRIEF DESCRIPTION OF THE DRAWINGS

FIG. 1 shows an example seismic acquisition system that may be used to generate seismic data according to the present disclosure.

FIG. 2 shows a flow chart of an example implementation of a method according to the present disclosure.

FIG. 3 shows an example implementation of a computer system that can implement a method according to the present disclosure.

### DETAILED DESCRIPTION

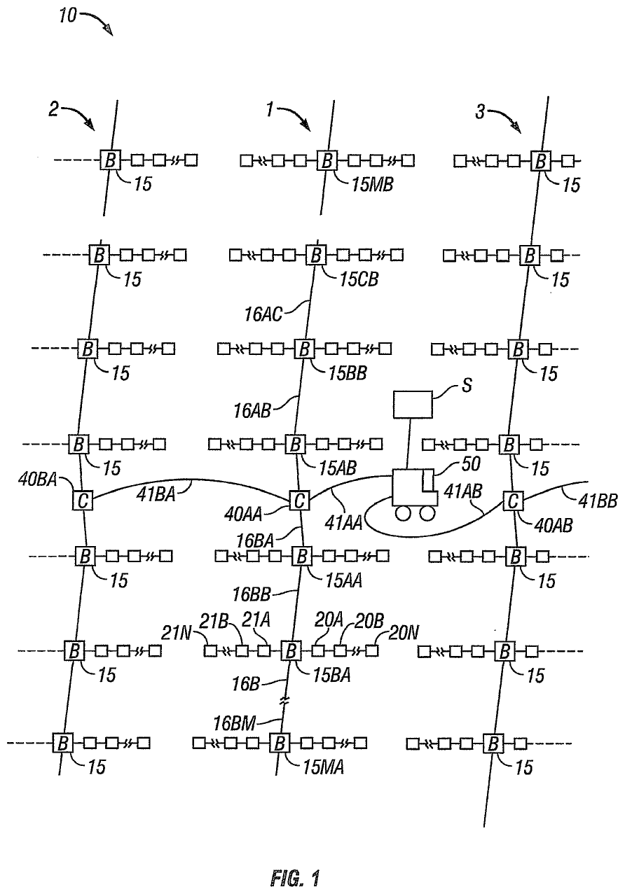

Seismic signals that may be processed in accordance with various aspects of the present disclosure may be acquired using equipment such as shown in FIG. 1. The equipment configuration may be referred to as a “spread” and is shown generally at 10. A recording unit 50 may be located at any topographically convenient position on the earth's surface relative to the spread 10. The recording unit 50 may include a digital data recorder (not shown separately) capable of simultaneous recording of digital signal samples from a plurality of separate seismic sensors, referred to as “channels.” Each channel represents signals generated by an individual seismic sensor in response to seismic energy imparted into the Earth by one or more seismic energy sources S. The source S, which is shown only schematically for clarity, may be any type of seismic energy source known in the art, including, without limitation, vibrator(s), explosives, air guns or water guns, or arrays of such guns and/or vibrators. The seismic sensors can be any type known in the art such as geophones, strings of geophones wired serially, or hydrophones. Another type of seismic sensor is a so-called three-component geophone, which includes three, orthogonally positioned geophones each arranged to respond to sensor motion along only one sensitive axis. Each of the three sensors in a three-component geophone may be connected a corresponding individual signal channel.

The recording unit 50 may further include equipment for controllably initiating the seismic energy source S. “Grids” or “lines” of seismic sensors which cover a predetermined area or traverse on the ground surface (or on the sea bottom in shallow marine surveys, for example) can be positioned within any geometric pattern the system operator determines is suitable in order to conduct the seismic survey. Methods for determining the geometric pattern of seismic sensors are known in the art. For example, a first grid, indicated at 1, positioned approximately in the center of FIG. 1, is shown extending from near the top to near the bottom of FIG. 1. The first grid 1 may be linked to the recording unit 50 by a dual-channel optical fiber 41AA, hereinafter referred to as a “C-link.” Seismic signal data generated by the seismic sensors within the first grid 1 may be ultimately conducted, as will be explained, to a data buffering unit, called a “C-unit” and generally shown at 40AA.

The C-unit 40AA can receive digital seismic signal data from two, dual-channel optical fibers, such as those shown at 16AB and 16BA and hereinafter referred to as “B-links”, for buffering and retransmission of signals sent by a so-called “B-unit” (such as one shown at 15AA), to the recording unit 50 over the C-link 41AA. In some embodiments, the digital bit-rate on the C-link may be about twice that of signals received over the B-links 16AB, 16BA. The B-links 16AB, 16BA may also be used for transmitting command signals generated by the recording unit 50, through the C-unit 40AA to the B-units.

The C-unit 40AA may also receive and buffer digital seismic signal data from other C-units, such as one shown for example at 40BA and forming the central data buffering and re-transmission unit for a second grid shown generally at 2. The C-unit 40AA in the first grid 1 receives digitized seismic signals from the C-unit 40BA of the second grid 2, over another C-link, shown as 41BA, which may be substantially identical to the C-link 41AA connecting the C-unit 40AA of the first grid 1 to the recording unit 50. Similarly, the C-unit 40BA of the second grid 2, can receive digitized seismic signals from still other grids (not shown) for eventual retransmission to the C-unit 40AA of the first grid 1, and ultimately to the recording unit 50. The connection to the C-units (not shown) of other grids (not shown) are made over other C-links, such as one shown at 41CA.

The recording unit 50 may receive digitized seismic signals simultaneously from two separate C-links, the second C-link shown generally at 41AB and being itself connected to a C-unit 40AB forming the central buffering and retransmission unit for a third grid, shown generally at 3.

The structure of the individual grids, such as the first grid 1, includes at least one, and may include a plurality of the B-units. B-units are shown generally at 15AA through 15MA for those B-units in the first grid 1 shown below the C-unit 40AA in FIG. 1. B-units are also shown generally at 15AB through 15MB for the B-units in the first grid 1 shown positioned above the C-unit 40AA in FIG. 1. The B-units 15AA, 15BA which are closest to the C-unit 40AA, are connected to the C-unit 40AA, as previously explained, by the dual-channel optical fiber link called a “B-link”, shown as 16AA and 16BA, respectively. The B-units 15AB, 15BB may receive command signals in optical telemetry conducted through the C-units from the recording unit 50 and reformat the command signals into electrical telemetry command signals provided to operate signal processing units, called A-units (shown in FIG. 1 as 21A through 21N).

The B-units, such as 15AB and 15BB, may be interconnected to the closest B-units 15AA, 15BA by other substantially identical B-links, shown generally at 16BB, 16AB. As will be further explained, each B-unit, such as 15AA, has enough internal data storage capacity to receive, buffer and retransmit digital signal from as many as 1,500 individual seismic sensor input channels. As will also be further explained, the B-units such as 15AA can be serially linked to each other by B-links into a series numbering twelve to thirteen of the B-units such as 15AA, depending on the sensor configuration geometry selected by the system operator and whether each B-unit is fully “loaded” with inputs from seismic sensors.

Each B-unit, such as 15AA, may be connected to the previously described A-units, shown for example at 21A through 21N as being connected to the B-unit 15BA. The A-units 21A through 21N, as will be further explained, each have three analog signal inputs (not shown in FIG. 1). The analog signal inputs are typically connected to the seismic sensors. The A-units digitize electrical signals generated by the seismic sensors and transmit the digitized signals by electrical signal telemetry to the B-unit to which they are connected.

The A-units, such as 21A-21N, may be assembled serially into a “string” having a plurality of A-units. Each B-unit such as 15BA may accept input from up to two such “strings”, the strings having a total number between them of as many as 80 of the A-units 21A-21N. As shown in FIG. 1, both of the A-unit inputs on each B-unit, such as 15AA, are used in order to form a substantially symmetrical configuration of serially linked A-units (21A-21N, and also 20A-20N) provided to each A-unit input of the B-unit 15AA. In the spread 10 shown in FIG. 1, the configuration of A-units 21A-21N and 20A-20N is repeated at each B-unit such as 15AA-15MA and 15AB-15MB, and that same pattern is repeated within each of the grids shown as 1, 2, and 3The sensor configuration shown in FIG. 1 is not exclusive.

The previously described seismic sensors (not shown separately for clarity of the illustration) may be connected to analog signal inputs (not shown for clarity) on the A-units 20A-20N. The seismic sensors are positioned in a pattern which can be determined by methods known in the art.

In a typical seismic survey, the seismic energy source S may be initiated by a control signal from the recording unit 50, as previously stated. Acoustic energy radiates into the earth, whereupon some of the acoustic energy can be reflected from acoustic impedance changes which may be present at various depths within the earth. The reflected acoustic energy propagates back to the earth's surface where it can be detected by the seismic sensors (not shown) connected to each of the A-units (such as 21A-21N). Signals generated by the sensors in response to the detected acoustic energy may be digitized in the A-units. The digitized signals from the A-units are transmitted electrically to the B-units. The B-units, as will be further explained, convert the electrical signals of the A-units into optical signals for retransmission, either directly to the recording unit 50, or alternatively to a C-unit. If the optical signals are retransmitted to a C-unit, then within the C-unit the signals can be combined with optical telemetry signals from other C-units for eventual retransmission to the recording unit 50. The recording unit 50 may generate a digital record of sensor signal amplitude, with respect to time, for each one of the sensor signals input to each A-unit.

The seismic acquisition system shown in FIG. 1 is only one example of seismic acquisition systems that may be used to obtain seismic data in accordance with the present disclosure and is not intended to limit the scope of the present disclosure.

Methods according to the present disclosure are based on observation of lower seismic wave velocities in shale formations than the expected velocities based on a normal compaction trend. Such lower velocities may be referred to as a velocity anomaly herein. Observation of such velocity anomaly is an indication as to the presence of nearby mature (or maturing) organic material bearing source rocks, which generally define an unconventional hydrocarbon prospect. The velocity anomaly should be conformal with the inferred prospect. The magnitude of the velocity anomaly will be related to, among other things, the source rock total organic carbon content, the thermal maturity of the source rock, and the volume of rock into which overpressured fluids have been expelled from the source rock. An “inferred prospect” is a velocity anomaly that has not yet been determined to be worthy of drilling one or more wells for hydrocarbons. Additional support to determine whether the inferred prospect is sufficiently well defined to justify drilling could be in the form of geological confirmation, e.g., other successful wells in the area at the same depth, geophysical support, e.g., a remote resistivity survey, or pore pressure information from basin modeling.

The overpressured fluids expelled from the source rock can be expected to produce a velocity anomaly substantially larger in depth and geographic width than the source rock interval, depending on the thermal maturity and the total organic carbon of the source rock interval.

In order to maximize horizontal resolution in determining the velocity anomaly, velocity analysis may be performed at each common midpoint (CMP) location in the seismic survey area to determine seismic interval velocity with respect to depth. Recorded seismic signals (“traces”) used for velocity analysis should be confined to narrow azimuthal bands so as to avoid conflating velocity anomalies due to thermal diagenesis with velocity anomalies due to azimuthal anisotropy.

2D extractions from a 3D velocity anomaly cube or difference cube (normal compaction trend velocity minus observed seismic interval velocity) should be parallel to the hydrocarbon source unit dip or strike. Vertical extractions will show the extent of migration into the overburden and underburden. An inferred prospect should be continuous and not “patchy.” Patchiness in the difference cube suggests low signal-to-noise, and hence less confidence that the low velocity anomaly corresponds to a hydrocarbon prospect. The velocity anomaly should be roughly conformal with a realistic geological model, including the effects of thermal maturation and also overpressure diffusion in the subsurface.

As a result of the fact that seismic multiple reflections will also have a lower than expected velocity based on the normal compaction trend, care should be taken to suppress multiples in initial data processing steps, because apparent seismic velocities in multiple reflections are not direct indicators of source rock maturity.

Because many unconventional prospects are structurally uncomplicated, obtaining interval velocities using the Dix equation will often provide acceptable accuracy. When more accuracy is desired, full waveform inversion may be performed. It is desirable that velocity model boundaries correspond to perfusion limits of diagenetic fluid pressures, so as to visualize the escaped diagenetic fluids velocity volume.

Using seismic velocity anomaly volumes may result in reduced drilling costs relative to “template drilling”, and lower the risks associated with unconventional field development.

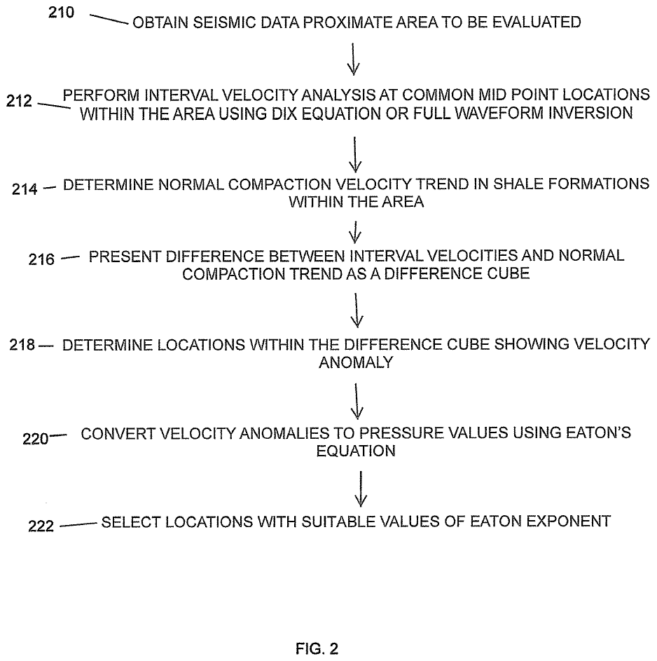

FIG. 2 is a flow chart of an example implementation of a method according to the present disclosure. At 210, seismic data may be obtained in an area to be evaluated. Seismic survey equipment, i.e., sources and receivers, may be disposed proximate the area in any known pattern or patterns used in reflection seismic surveying.

At 212, interval velocity analysis may be performed, e.g., using the Dix equation at common mid point (CMP) locations in the survey area or by using full waveform inversion.

At 214, a normal compaction trend of seismic velocity (velocity with respect to depth) in shale formations in the area may be determined.

At 216, the determined interval velocities from 12 may be compared to the normal compaction trend, e.g., by subtraction at each CMP location at corresponding depths. Differences between the normal compaction trend and the determined interval velocities may be presented in visual form, e.g., as a difference cube.

At 218, locations showing velocity anomalies within the difference cube may be determined. At 220, the velocity anomalies may be used to quantify formation fluid pressures, e.g., using Eaton's equation.

At 222, geodetic locations showing both highest values of pore pressure and high Eaton's exponent (approximately 6 to 8) may be identified as locations most likely to have commercially producible unconventional hydrocarbons; the product of pore pressure times Eaton's exponent will identify overpressured zones wherein the product modulates the pore pressure to indicate where diagenesis is occurring.

More detailed description of some of the actions described with reference to FIG. 2 follows.

At 212, after the stacking velocities have been picked, and converted to interval velocities, or after full waveform inversion (FWI) velocities have been produced, a “difference cube” can be calculated at 216 by subtracting the seismic survey velocity volume from the normal compaction velocity trend, determined at 14. It is desirable to identify and suppress multiple reflections, which will provide spurious lower velocities.

Large values in the difference cube, at 218 in FIG. 2, indicate where the seismic survey velocities are substantially lower than the normal compaction trend velocities. The difference cube may be viewed in 3D, for example, in modulated transparency, where lower values in the difference cube are transparent, and may be ignored. Negative difference values correspond to high velocity lithologies and may also be ignored. By tuning the transparency threshold, a volume can be produced in which only the lowest velocities are opaque. When contoured, these low velocity anomalies may be identified initial prospects. A display, such as a graph or map may be generated to show the geodetic location of one or more identified initial prospects.

In a mature basin, the initial prospects should be compared in depth to previously discovered unconventional hydrocarbon wells, and similar depths (adjusting for horizontally variable structuration) will add to confidence in the initial prospects.

Additionally, the initial prospects should have a shape consistent with pressure developing in the presumed shale unit, and then perfusing out into nearby lithologies both vertically and laterally. That is, the low velocity anomaly should be highest in the center of the shale, and then reduce as distance from the center increases.

The velocity cube should be converted to pressure, at 220, by means of Eaton's transform. Initial tests may be performed with an Eaton exponent of 3 (consistent with differential compaction) and with 8 (consistent with diagenetic expulsion). If the transform predicts pressures above the frac gradient, then the exponent is too high. A value of 3 would eliminate an initial prospect from consideration, while a value of 8 would give more confidence in drilling a test well. Expressed differently, a prospect should have a slightly reduced velocity (indicating diagenetic expulsion) but not a strongly reduced velocity (indicating differential compaction). Thus, the Eaton exponent should be a suitable value for identifying unconventional prospects.

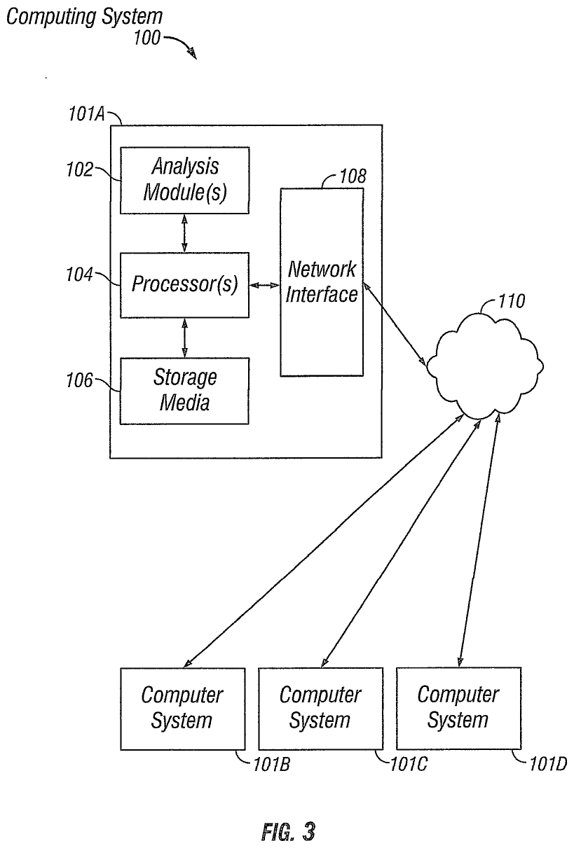

The foregoing process explained with reference to FIG. 2 may be implemented on any form of computer or computer system programmed to perform the actions described. FIG. 3 shows an example computing system 100 in accordance with some embodiments. The computing system 100 may be an individual computer system 101A or an arrangement of distributed computer systems. The individual computer system 101A may include one or more analysis modules 102 that may be configured to perform various tasks according to some embodiments, such as the tasks explained with reference to FIG. 3. To perform these various tasks, the analysis module 102 may operate independently or in coordination with one or more processors 104, which may be connected to one or more storage media 106. A display device 105 such as a graphic user interface of any known type may be in signal communication with the processor 104 to enable user entry of commands and/or data and to display results of execution of a set of instructions according to the present disclosure.

The processor(s) 104 may also be connected to a network interface 108 to allow the individual computer system 101A to communicate over a data network 110 with one or more additional individual computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well drilling location, while in communication with one or more computer systems such as 101C and/or 101D that may be located in one or more data centers on shore, aboard ships, and/or located in varying countries on different continents).

A processor may include, without limitation, a microprocessor, microcontroller, processor module or subsystem, programmable integrated circuit, programmable gate array, or another control or computing device.

The storage media 106 may be implemented as one or more computer-readable or machine-readable storage media. Note that while in the example embodiment of FIG. 3 the storage media 106 are shown as being disposed within the individual computer system 101A, in some embodiments, the storage media 106 may be distributed within and/or across multiple internal and/or external enclosures of the individual computing system 101A and/or additional computing systems, e.g., 101B, 101C, 101D. Storage media 106 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that any other embodiment of a computing system may have more or fewer components than shown, may combine additional components not shown in the example embodiment of FIG. 3, and/or the computing system 100 may have a different configuration or arrangement of the components shown in FIG. 3. The various components shown in FIG. 3 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, GPUs, coprocessors or other appropriate devices. These modules, combinations of these modules, and/or their combination with general hardware are all included within the scope of the present disclosure.

In light of the principles and example implementations described and illustrated herein, it will be recognized that the example implementations can be modified in arrangement and detail without departing from such principles. The foregoing discussion has focused on specific implementations, but other configurations are also contemplated. In particular, even though expressions such as in “an implementation,” or the like are used herein, these phrases are meant to generally reference implementation possibilities, and are not intended to limit the disclosure to particular implementation configurations. As used herein, these terms may reference the same or different implementations that are combinable into other implementations. As a rule, any implementation referenced herein is freely combinable with any one or more of the other implementations referenced herein, and any number of features of different implementations are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A method for identifying unconventional hydrocarbon prospects using reflection seismic data acquired proximate an area of Earth's subsurface to be evaluated, the method comprising:
determining interval velocities at a plurality of locations proximate the area;
determining a normal compaction trend of seismic velocities in shale formations proximate the area;
determining one or more low velocity anomalies from the interval velocities and the normal compaction trend;
identifying at least one unconventional hydrocarbon prospect location from the one or more low velocity anomalies;
generating a display showing the at least one unconventional hydrocarbon prospect location.

2. The method of claim 1 wherein the interval velocities are determined using at least one of the Dix equation or full waveform inversion.

3. The method of claim 1 wherein the one or more low velocity anomalies are determined by calculating a difference cube.

4. The method of claim 1 further comprising calculating fluid pressure in at least one subsurface formation by converting a magnitude of the one or more low velocity anomalies using Eaton's equation.

5. A non-transitory computer readable medium having stored thereon a computer program, te program comprising logic operable to cause a programmable computer to perform acts, comprising:
accepting as input to the computer or computer system reflection seismic data acquired proximate an area of Earth's subsurface to be evaluated, the method comprising:
determining interval velocities at a plurality of locations proximate the area;
determining a normal compaction trend of seismic velocities in shale formations proximate the area;
determining one or more low velocity anomalies from the interval velocities and the normal compaction trend; and
identifying at least one unconventional hydrocarbon prospect location from the one or more low velocity anomalies.

6. The computer readable medium of claim 5 wherein the interval velocities are determined using at least one of the Dix equation or full waveform inversion.

7. The computer readable medium of claim 5 wherein the one or more low velocity anomalies are determined by calculating a difference cube.

8. The computer readable medium of claim 5 further comprising logic operable to cause the computer or computer system to perform calculating fluid pressure in at least one subsurface formation by converting a magnitude of the one or more low velocity anomalies using Eaton's equation.

9. A method for identifying unconventional hydrocarbon prospects, comprising:
obtaining reflection seismic data acquired proximate an area of Earth's subsurface to be evaluated by actuating at least one seismic energy source and detecting seismic energy at a plurality of detectors disposed proximate the area;
determining interval velocities at a plurality of locations proximate the area;
determining a normal compaction trend of seismic velocities in shale formations proximate the area;
determining one or more low velocity anomalies from the interval velocities and the normal compaction trend;
identifying at least one unconventional hydrocarbon prospect location from the one or more low velocity anomalies;
generating a display showing the at least one unconventional hydrocarbon prospect location.

10. The method of claim 9 wherein the interval velocities are determined using at least one of the Dix equation or full waveform inversion.

11. The method of claim 9 wherein the one or more low velocity anomalies are determined by calculating a difference cube.

12. The method of claim 9 further comprising calculating fluid pressure in at least one subsurface formation by converting a magnitude of the one or more low velocity anomalies using Eaton's equation.
